(19) United States
(12) Patent Application Publication
(10) Pub. No.: US 2015/0326480 A1
(43) Pub. Date: Nov. 12, 2015

(54) CONDITIONAL ACTION FOLLOWING TCAM FILTERS

(71) Applicant: Alcatel Lucent, Boulogne-Billancourt (FR)

(72) Inventors: Andrew Dolganow, Ottawa (CA); Mark French, Amersham (GB)

(21) Appl. No.: 14/272,007

(22) Filed: May 7, 2014

(51) Int. Cl. H04L 12/803; H04L 12/54

(52) U.S. Cl. CPC H04L 47/125; H04L 12/5689

(57) ABSTRACT

A method for providing a conditional action following TCAM lookup is disclosed. The method for providing a conditional action following TCAM lookup includes obtaining data; generating a lookup key from the data; performing a TCAM lookup using the key; and in the event the TCAM lookup generates a match, then performing an test to determine if there is exists a condition associated with the action associated with that match, and in the event the there is a condition, evaluating said condition associated with the action of that match entry; and in the event that said condition is satisfied, then performing a conditional action. The data may be from a communications packet header, the condition evaluation may be one of packet length or Time to Live (TTL) value, and the action taken may be one of dropping or forwarding a communications packet. The method for providing a conditional action following TCAM lookup is particularly useful for reducing the quantity of entries in a TCAM of TCAM filters known in the art.

### FIELD OF THE INVENTION

The invention relates to packet filtering via TCAMs (Ternary Content Addressable Memories), and is particularly concerned with conditional action determination following packet filtering via TCAMs.

### BACKGROUND OF THE INVENTION

Communication packet classification is a key step in network elements within communication networks for various functions such as routing, creating firewalls, load balancing and differentiated services. Upon arrival at a network element, communication packets may be classified into different flows based on packet header fields and using a table of rules in which each rule is of the form (M, A), where M is a set of match criteria and A is an action to perform upon match. When an incoming communication packet matches a rule in the classifier, its associated action determines how the communication packet is handled. Possible actions include dropping the packet, forwarding to an appropriate output port for transmission to another network element, forwarding to a specified service function like Network Address Translation or tunnel encapsulation, or directing the packet to a pre-specified destination as in Policy Based Routing (PBR).

Incoming packet classification via TCAM based solutions operates by building a TCAM key based on portions of the received communication packet, typically but not restricted to portions in the header of the packet; performs a TCAM lookup to determine if there is a match to an entry in the TCAM; and in the event that there is a match, then returning an associated action (directly or as a memory reference to another table) to execute; and finally executing the associated action in an ASIC/NPU/CPU (Application Specific Integrated Circuit/Network Processor Unit/Central Processor Unit).

These steps are illustrated in the process flow diagram of FIG. 1. The process commences at step 102. At step 104 relevant fields of data are obtained from the communications packet, typically but not restricted to the Layer 2, Layer 3 and Layer 4 header portions of the communications packet—as for example in cases of Deep Packet Inspection processing wherein portions of payload contents may be used. At step 106 a search key is formed from this data, the search key conforming to match criteria encoding previously established and stored in a TCAM—including criteria such as Access Control Lists (ACLs), Quality of Service (QoS) indicators, address ranges, and the like. At step 110 the search key is presented to the TCAM and an evaluation is performed as to whether the key matches any entry in the TCAM. In the event that a match is found, the TCAM and associated circuitry provide an associated action to the match entry, and at step 112 the associated action is performed. The process then proceeds to step 116 wherein this instance of the process ends. In the event that a match is not found, the TCAM indicates such, and at step 114 a default action is performed. The process then proceeds to step 116 wherein this instance of the process ends.

The problem with this solution is that a TCAM implementation has scalability constraints. The more specific that one makes the criteria for a match, the smaller the range of possibilities that can be covered by the criteria. A common work around that is to create multiple instances of filters which correspond to different conditions of a given criteria with other aspects of the key held the same, but this requires more and more space in the TCAM. For a given TCAM size there is a granularity tradeoff. If flexibility around different match criteria is desired, then some other criteria will be required to lose resolution, alternatively if address range resolution is desired then the number of filter types will have to decrease—as different filters implies a different set of match criteria in a packet.

### SUMMARY OF THE INVENTION

It is an object of the invention to provide a method which allows for a conditional action to be evaluated and appropriately responded to after a TCAM match operation.

According to an aspect of the invention there is disclosed a method for conditional filtering following a TCAM lookup, the method having the steps of: obtaining data; generating a lookup key from the data; performing a TCAM lookup using the key; and in the event the TCAM lookup generates a match, then performing an test to determine if there is exists a condition associated with the action associated with that match, and in the event the there is a condition, evaluating the condition associated with the action of that match entry; and in the event that the condition is satisfied, then performing a conditional action.

In some embodiments of the invention in the event the TCAM lookup does not generate a match, then there is a step of performing a default action. In some embodiments of the invention in the event that the condition is not satisfied, then there is a step of performing a default conditional action. In yet other embodiments of the invention in the event that there exists no condition with the action associated with that match, then there is a step of performing that associated action.

In other embodiments of this aspect of the invention the data is obtained from at least a portion of the header of a communications packet. In some of these embodiments the condition comprises one of the set of a packet length and a Time to Live (TTL) value.

In yet other embodiments of this aspect of the invention the action taken comprises one of the set of dropping the communications packet, forwarding the communications packet, and forwarding the communications packet according to Policy Based Routing (PBR).

In some embodiments of this aspect of the invention the action taken is prior to forwarding at least a portion of the packet across a switching fabric. In other embodiments of this aspect of the invention the TCAM lookup is prior to forwarding at least a portion of the packet across a switching fabric, while in other embodiments the TCAM lookup is after at least a portion of the packet has been forwarded across a switching fabric.

According to another aspect of the invention there is disclosed a non-transitory machine-readable storage medium encoded with instructions for execution by a network device, the medium having: instructions for obtaining data; instructions for generating a lookup key from the data; instructions for performing a TCAM lookup using the key; and instructions for in the event the TCAM lookup generates a match, then performing an test to determine if there is exists a condition associated with the action associated with that match, and instructions for in the event the there is a condition, evaluating the condition associated with the action of that match entry; and instructions for in the event that the condition is satisfied, then performing a conditional action.

In some embodiments of this aspect of the invention the non-transitory machine-readable storage medium further includes instructions for obtaining the data from at least a portion of the header of a communications packet.

In some embodiments of this aspect of the invention the non-transitory machine-readable storage medium further includes instructions that the condition comprises one of the set of a packet length and a Time to Live (TTL) value. In other embodiments of this aspect of the invention the non-transitory machine-readable storage medium further includes instructions that the action taken comprises one of the set of dropping the communications packet, forwarding the communications packet, and forwarding the communications packet according to Policy Based Routing (PBR).

According to yet another aspect of the invention there is disclosed an apparatus for conditional filtering following a TCAM lookup, the apparatus having: a lookup key generator for generating a lookup key based upon input data; a TCAM for accessing with the lookup key; and an evaluator which in the event a lookup of the TCAM via the lookup key generates a match, then performs an test to determine if there is exists a condition associated with the action associated with that match, and in the event the there is a condition, evaluates the condition associated with the action of that match entry; and in the event that the condition is satisfied, then instructs a conditional action.

In some embodiments of this aspect of the invention the lookup key generator obtains the input data from at least a portion of the header of a communications packet.

In some embodiments of this aspect of the invention the condition comprises one of the set of a packet length and a Time to Live (TTL) value. In some embodiments of this aspect of the invention the action instructed comprises one of the set of dropping the packet, forwarding the packet, and forwarding the packet according to Policy Based Routing (PBR).

Note: in the following the description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which like reference numbers are used to represent like elements, and:

FIG. 1 illustrates a process flow chart of a TCAM lookup according to the prior art;

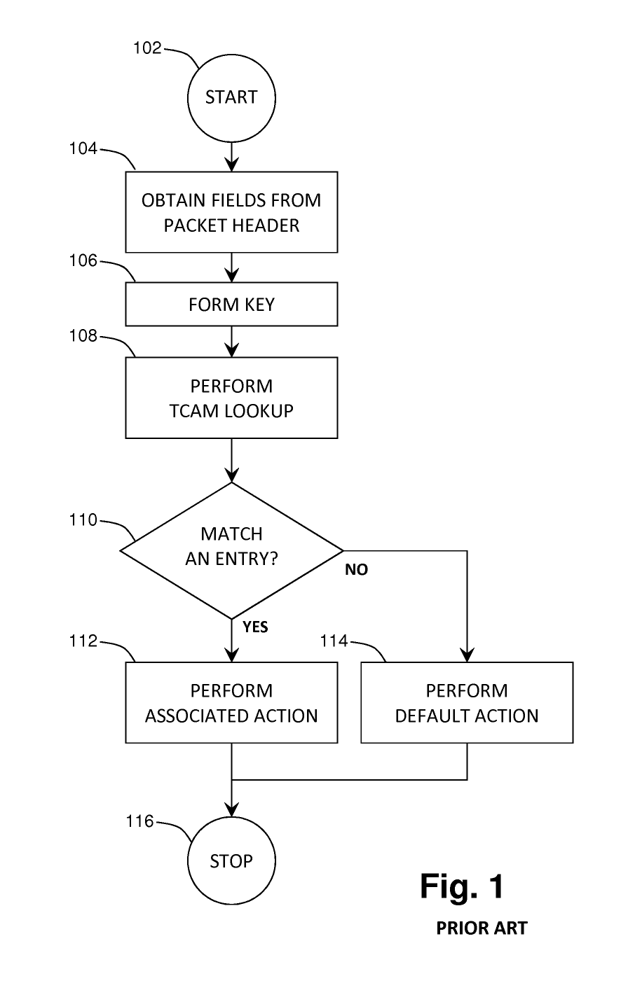

FIG. 2 illustrates a process flow chart of a conditional action following a TCAM lookup, according to an embodiment of the invention; and

FIG. 3 depicts a high level block diagram of a computing device, such as a processor in a telecom network element, suitable for use in performing functions described herein.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such a feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

The techniques shown in the figures can be implemented using code and data stored and executed on one or more electronic devices (e.g., a network element). Such electronic devices store and communicate (internally and with other electronic devices over a network) code and data using machine-readable media, such as machine storage media (e.g., magnetic disks; optical disks; random access memory; read only memory; flash memory devices) and machine communication media (e.g., electrical, optical, acoustical or other form of propagated signals—such as carrier waves, infrared signals, digital signals, etc.). In addition, such electronic devices typically include a set of one or more processors coupled to one or more other components, such as a storage device, one or more user input/output devices (e.g., a keyboard and/or a display), and a network connection. The coupling of the set of processors and other components is typically through one or more busses and bridges (also termed as bus controllers). The storage device and signals carrying the network traffic respectively represent one or more machine storage media and machine communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, firewall, etc.) is a piece of networking equipment, including hardware and software that communicatively interconnects other equipment on the network (e.g., other network elements, computer end stations, etc.). Customer computer end stations (e.g., workstations, laptops, palm tops, mobile phones, etc.) access content/services provided over the Internet and/or content/services provided on associated networks such as the Internet. The content and/or services are typically provided by one or more server computing end stations belonging to a service or content provider, and may include public webpages (free content, store fronts, search services, etc.), private webpages (e.g., username/password accessed webpages providing email services, etc.), corporate networks over VPNs, etc. Typically, customer computing end stations are coupled (e.g., through customer premise equipment coupled to an access network, wirelessly to an access network) to edge network elements, which are coupled through core network elements of the Internet to the server computing end stations.

In general in the description of the figures, like reference numbers are used to represent like elements.

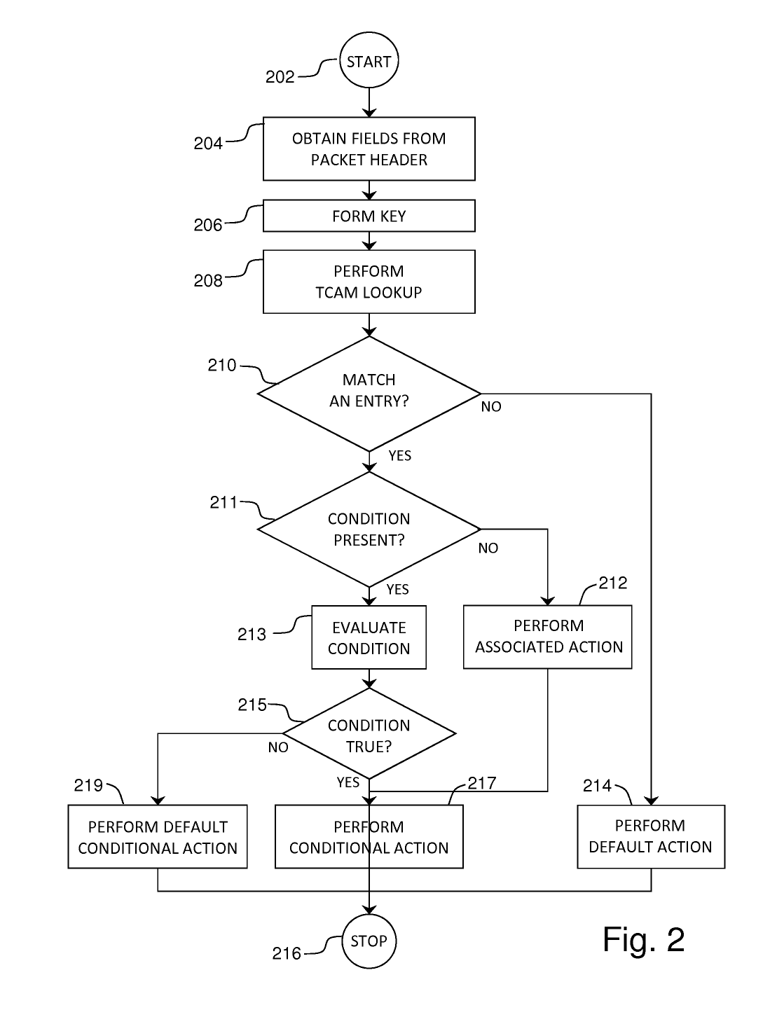

Referring now to FIG. 2, there may be seen a process flow chart according to an embodiment of the invention. The process commences at step 202.

At step 204 relevant fields of data are obtained from the communications packet, typically but not restricted to the header portion of the communications packet—as for example in cases of Deep Packet Inspection processing wherein portions of payload contents may be used.

At step 206 a search key is formed from this data, the search key conforming to match criteria previously established and stored in a TCAM—including criteria such as Access Control Lists (ACLS), Quality of Service (QoS) indicators, address ranges, and the like.

At step 210 the search key is presented to the TCAM and an evaluation is performed as to whether the key matches any entry in the TCAM.

In the event that a match is not found, a default action is performed at step 214. The process then proceeds to step 216 wherein this instance of the process ends.

In the event that a match is found, the TCAM and associated circuitry provide an associated action to the match entry. This associated action may be a normal action or a conditional action. Control then passes to step 211 wherein the associated action is evaluated as to whether there is a condition present.

In the event that the associated action has no condition, the process proceeds to step 212 where the associated action is performed. The process then proceeds to step 216 wherein this instance of the process ends.

In the event that the associated action has a condition, the process proceeds to step 213 where the condition is evaluated. The process then proceeds to step 215 the results of the evaluation are assessed.

In the event the condition is true, the process proceeds to step 217 where the conditional action is performed. The process then proceeds to step 216 wherein this instance of the process ends.

In the event the condition is not true, the process proceeds to step 219 where the default conditional action is performed. In some embodiments the default conditional action may be the same as the default action of step 214. The process then proceeds to step 216 wherein this instance of the process ends.

Default actions may consist of dropping the communication packet, or alternatively forwarding the communication packet.

Associated actions may consist of dropping the communication packet; forwarding the communication packet towards particular ports in the network element for ultimate transmission to other network elements; forwarding the communication packet to a pre-specified destination as in Policy Based Routing (PBR); or specifying criteria such as QoS criteria which will affect how the communications packet is subsequently handled in the network element.

Conditional actions consist of an additional test that is performed, with the resulting associated action a function of the results of the evaluation of the condition. By way of example, one condition may be that of packet length. Should the communications packet conform to certain criteria that produce a match in the TCAM, a conditional action could specify an additional test with respect to the length of the communication packet. If the length is below a certain threshold, then the resultant conditional action may be to forward the packet, whereas if the length exceeds the threshold the resultant conditional action would be to drop the communication packet. Alternatively, the obverse condition could apply—in that If the length is above a certain threshold, then the resultant conditional action may be to forward the packet, whereas if the length is below the threshold the resultant conditional action would be to drop the communication packet.

In some embodiments the conditional evaluation is packet-length performed against TotalLength field of an IPv4 header or PayloadLength field of an IPv6 header. Alternatively the conditional evaluation may be in regards to the total packet length of the packet (L2 or L3 layer or user data).

Another conditional criteria which may be used, by way of example, is the Time to Live (TTL) value associated with an IP communications packet. A conditional action in reference to this criteria would evaluate the TTL value against a preset threshold or range, and as a result of the evaluation either forward or drop the communication packet. In some embodiments the conditional evaluation may be TTL performed against the TTL field in an IPv4 header or the HopLimit field in an IPv6 header.

Conditional actions are not limited to dropping or forwarding a packet, but may include any action that would normally result from a TCAM match, the difference being that the action would be taken subsequent to both a TCAM match and satisfaction of the pre-specified condition. In general, any of the actions—default, default conditional, associated, and associated conditional may be any type of action. For example, additional actions beyond those already described include forwarding all or a portion of the communication packet to a queue, policing, and forwarding all or a portion of the communication packet for internal processing. It is contemplated that the list of actions will expand as the complexity of network element activities increases.

In general, it is contemplated that conditions may be performed on any match criteria in the TCAM with the understanding that it is preferable that those conditions that are less likely to be matched are moved out of the TCAM, so the frequency of matches does not impact normal operating performance. It is understood that those skilled in the art will be able to adjust the allocation of TCAM match versus TCAM AND Condition Match in a particular embodiment in order to best tradeoff the scale, flexibility and performance requirements of a particular deployment. Differing types of service, differing filter types, and differing equipment types may all employ embodiments of the invention in order to effect the advantages of the invention.

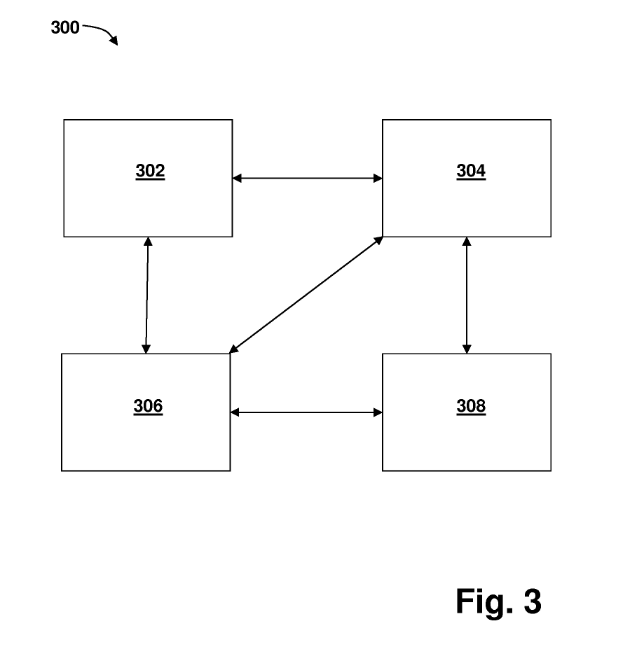

Referring now to FIG. 3, a network equipment processor assembly 300 which in certain embodiments may be used in the handling of packets, includes a network equipment processor element 306 (e.g., a central processing unit (CPU) and/or other suitable processor(s)), a memory 308 (e.g., random access memory (RAM), read only memory (ROM), and the like), a cooperating module/process 302, and various input/output devices 304 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in hardware, for example using one or more application specific integrated circuits (ASIC), and/or any other hardware equivalents. Alternatively, according to one embodiment, the cooperating process 302 can be loaded into memory 308 and executed by network equipment processor 306 to implement the functions as discussed herein. As well, cooperating process 302 (including associated data structures) can be stored on a tangible, non-transitory computer readable storage medium, for example magnetic or optical drive or diskette, semiconductor memory and the like.

It is contemplated that some of the steps discussed herein as methods may be implemented within hardware, for example, as circuitry that cooperates with the network equipment processor to perform various method steps. Portions of the functions/elements described herein may be implemented as a computer program product wherein computer instructions, when processed by a network equipment processor, adapt the operation of the network equipment processor such that the methods and/or techniques described herein are invoked or otherwise provided. Instructions for invoking the inventive methods may be stored in fixed or removable media, and/or stored within a memory within a computing device operating according to the instructions.

Note, in the preceding discussion a person of skill in the art would readily recognize that steps of various above-described methods can be performed by appropriately configured network processors. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices are all tangible and non-transitory storage media and may be, e.g., digital memories, magnetic storage media such as a magnetic disks and magnetic tapes, hard drives, or optically readable digital data storage media. The embodiments are also intended to cover network element processors programmed to perform said steps of the above-described methods.

Numerous modifications, variations and adaptations may be made to the embodiment of the invention described above without departing from the scope of the invention, which is defined in the claims.

What is claimed is:

1. A method for conditional filtering following a TCAM lookup, the method comprising the steps of:
obtaining data;
generating a lookup key from said data;
performing a TCAM lookup using said key; and
in the event the TCAM lookup generates a match, then performing an test to determine if there is exists a condition associated with the action associated with that match, and
in the event the there is a condition, evaluating said condition associated with the action of that match entry; and
in the event that said condition is satisfied, then performing a conditional action.

2. The method of claim 1, wherein
in the event the TCAM lookup does not generate a match, then performing a default action.

3. The method of claim 1, wherein
in the event that said condition is not satisfied, then performing a default conditional action.

4. The method of claim 1, wherein
in the event that there exists no condition with the action associated with that match, then performing that associated action.

5. The method of claim 1, wherein
said data is obtained from at least a portion of the header of a communications packet.

6. The method of claim 5, wherein
the condition comprises one of the set of a packet length and a Time to Live (TTL) value.

7. The method of claim 5, wherein
the action taken comprises one of the set of dropping said communications packet, forwarding said communications packet, and forwarding said communications packet according to Policy Based Routing (PBR).

8. The method of claim 5, wherein
the action taken is prior to forwarding at least a portion of said packet across a switching fabric.

9. The method of claim 5, wherein
said TCAM lookup is prior to forwarding at least a portion of said packet across a switching fabric.

10. The method of claim 5, wherein
said TCAM lookup is after at least a portion of said packet has been forwarded across a switching fabric.

11. A non-transitory machine-readable storage medium encoded with instructions for execution by a network device, the medium comprising:
instructions for obtaining data;
instructions for generating a lookup key from said data;
instructions for performing a TCAM lookup using said key; and
instructions for in the event the TCAM lookup generates a match, then performing an test to determine if there is exists a condition associated with the action associated with that match, and
instructions for in the event the there is a condition, evaluating said condition associated with the action of that match entry; and
instructions for in the event that said condition is satisfied, then performing a conditional action.

12. The non-transitory machine-readable storage medium of claim 11, further comprising:
instructions for obtaining said data from at least a portion of the header of a communications packet.

13. The non-transitory machine-readable storage medium of claim 12, further comprising:
instructions that the condition comprises one of the set of a packet length and a Time to Live (TTL) value.

14. The non-transitory machine-readable storage medium of claim 12, further comprising:
instructions that the action taken comprises one of the set of dropping said communications packet, forwarding said communications packet, and forwarding said communications packet according to Policy Based Routing (PBR).

15. An apparatus for conditional filtering following a TCAM lookup, the apparatus comprising:
a lookup key generator for generating a lookup key based upon input data;
a TCAM for accessing with said lookup key; and
an evaluator which in the event a lookup of said TCAM via said lookup key generates a match, then performs an test to determine if there is exists a condition associated with the action associated with that match, and
in the event the there is a condition, evaluates said condition associated with the action of that match entry; and
in the event that said condition is satisfied, then instructs a conditional action.

16. The apparatus for conditional filtering following a TCAM lookup of claim 15, further comprising:
said lookup key generator obtaining said input data from at least a portion of the header of a communications packet.

17. The apparatus for conditional filtering following a TCAM lookup of claim 16 further comprising:
that said condition comprises one of the set of a packet length and a Time to Live (TTL) value.

18. The apparatus for conditional filtering following a TCAM lookup of claim 16 further comprising:
that said action instructed comprises one of the set of dropping said packet, forwarding said packet, and forwarding said packet according to Policy Based Routing (PBR).
